(19) United States
(12) Patent Application Publication
(10) Pub. No.: US 2015/0288106 A1
(43) Pub. Date: Oct. 8, 2015

(54) Electrical Connector

(71) Applicant: Chant Sincere Co., Ltd., NEW TAIPEI (TW)

(72) Inventors: Chih-Chien LIN, New Taipei (TW); Ming Hui YEN, New Taipei (TW); Chun Chi CHOU, New Taipei (TW); Wen-Ta CHIU, New Taipei (TW); Huagu ZI, New Taipei (TW); Yu Chin CHIEN, New Taipei (TW); Lien-Hsi WU, New Taipei (TW)

(21) Appl. No.: 14/656,020

(22) Filed: Mar. 12, 2015

(30) Foreign Application Priority Data
Apr. 8, 2014 (TW) 103205994
May 23, 2014 (TW) 103209065

(51) Int. Cl. H01R 13/6581; H01R 13/405

(52) U.S. Cl. CPC H01R 13/6581; H01R 13/405

(57) ABSTRACT

The electrical connector comprises the shielding component provided with a hollow chamber. The principle housing installed in said hollow chamber, including a main body and a tongue protruded from said main body in a longitudinal direction, wherein said tongue is more closer to said opening, and a vacant portion provided by the bottom of said main body, a plurality of first compressed terminals been insert-molded to an upper surface of said main body. A plurality of second compressed terminals been insert-molded to said main body and received by said recessions. A supplementary housing disposed in part of said vacant portion nearby the location of said tongue. A plurality of liberative terminals been retained on said supplementary housing.

### CROSS-REFERENCE TO RELATED APPLICATIONS

This application claims the benefit of the filing date under 35 U.S.C. §119(a)-(d) of Taiwan Patent Applications No. 103205994, filed Apr. 8, 2014, and No. 103209065, filed May 23, 2014.

### BACKGROUND OF THE INVENTION

1. Field of the Invention

The present invention is related to an electrical connector, and more particularly to an electrical connector having new type of assembling components.

2. Description of the Related Art

FIG. 1 is an exploded view of a prior electrical connector. Please refer to FIG. 1, which illustrates a USB connector with structure combining a built-in card-reading slot of a Taiwanese patent no. M407466, generally comprising an insulating substrate 10, a first insulating block 32, a first set of terminals 20, a second insulating block 40, a third insulating block 51, a third set of terminals 50 and a metal casing 70. The insulating substrate 10 includes a first surface 11 and a second surface 12. The first surface 11 provides a plurality of first installing grooves 13 and second installing grooves 14 on which a plurality of terminals are disposed, wherein both rear sides of the insulating substrate 10 are provided with a first groove 15 and a second groove 16. The first insulating block 32 is disposed on the first surface 11 of the insulating substrate 10. The first insulating block 32 provides a plurality of guide grooves 33 on its bottom surface in positions corresponding to the first installing groove 13. The top surface of the first insulating block 32 is provided with a plurality of first inlaying grooves 34. Two sides of the first insulting block 13 are provided with first engaging slots 35 which are in positions corresponding to the first grooves 15 of the insulating substrate 10. The first set of terminals 20 axially extends through the first inlaying grooves 34 by enabling protruding spines 22 of the first set terminals 20 to be grasped by the first inlaying grooves 34 for a purpose of positioning, and enabling the rear of the first set of terminals 20 to extend to form a first set of pins 21. The first insulating block 32 and the first type terminal group 20 are thus formed as a first connecting unit 60a. The second insulating block 40 is disposed on the first surface 11 of the insulating substrate 10 at a position in front of the first insulating block 32. The bottom of the second insulating substrate 40 is provided with a plurality of second inserting grooves 41. Second engaging slots 42 are provided on both sides of the second insulating substrate 40 in a position corresponding to the second groove 16 of the insulating substrate 10. The third insulating block 51 is allocated on the second surface 12 of the insulating substrate 10. The bottom of the third insulating block 51 is provided with a plurality of third inlaying grooves 52. Both sides of the third insulating block 51 are respectively provided with first card claspers 53a and second card claspers 53b extending upwards and in a position corresponding to the first groove 15 and the second groove 16. The first card clasper 53a and the second card clasper 53b extend upwards through the bottom of the insulating substrate 10 to respectively hook the corresponding first engaging slot 35 of the first insulating block 32 and the second engaging slot 42 of the second insulating block 40 in such a manner that the insulating substrate 10, the first insulating block 32, the second insulating block 40 and the third insulating block 51 are thus formed as a assembled connecting module 60. The front of the third set of terminals 50 is provided with protruding spines, which are allocated on two sides of the terminal to stick into the third inlaying grooves 52 of the third insulating block 51. The rear of the set of terminals 50 extends to expose outside of the third insulating block 51 to form a third group of pins 56, thereby forming a third connecting unit 60c. The metal casing 70, which covers the assembled connecting module 60, is made of metal complying a dimension regulation for a USB Type-A connector of USB Type-A Communications Protocol. The metal casing 70 includes a first wall 71 at the top and a second wall 72 at the bottom respectively. A space between the front of the first wall 71 and the first surface 11 of the insulating substrate 10 thus form as first slot for electrically being connected to a USB female connector complying to USB 2.0 or USB 3.0 Communications Protocol. In addition, a space between the second wall 72 and the second surface 12 of the insulating substrate 10 forms a second slot for being inserted by a thin-type Micro SD/T-Flash memory card. The front of the third set of terminals is exposed within the second slot to enable the second slot to form a thin-type card-reading slot for the Micro SD/T-Flash memory card. Accordingly, the prior art utilizes the insulating substrate 10 and two or three different types of insulating blocks 32, 40 and 51 to hook together with each other to form a module by which each insulating block uses concave grove to meet the requirement of USB specification with desired functions according to different demands by selecting different types of terminals.

However, the above design does not make perfect. Not only the production processes of the product are complicated, but also the cost of mold is astonishing high to thus the competitiveness of product is greatly reduced. Although the concept is very good, the workmanship is not ideal. Therefore, it is an issue to develop a product which can retain the advantages of multiple functions and stand the test of the marketplace.

### SUMMARY OF THE INVENTION

The present invention provides an electrical connector which has simpler producing procedure and lower cost.

The electrical connector comprises the shielding component provided with a hollow chamber. The principle housing installed in said hollow chamber, including a main body and a tongue protruded from said main body in a longitudinal direction, wherein said tongue is more closer to said opening, and wherein said main body includes recessions extending in said longitudinal direction, and a vacant portion provided by the bottom of said main body, a plurality of first compressed terminals been insert-molded to an upper surface of said main body. A plurality of second compressed terminals been insert-molded to said main body and received by said recessions. A supplementary housing disposed in part of said vacant portion nearby the location of said tongue. A plurality of liberative terminals been retained on said supplementary housing, wherein the major part of terminal body of above-described first compressed terminals, second compressed terminals and liberative terminals are respectively on the planes which share no co-planar.

In one embodiment of the present invention, a first space communicated with said opening is defined between said upper surface and said shielding component of said principle housing; and a second space communicated with said opening is defined between a bottom surface of said tongue portion, said supplementary housing and said shielding component.

In one embodiment of the present invention, said first compressed terminals, said second compressed terminals and said liberative terminals respectively include a first contact portion, a second contact portion and a third contact portion near to said opening, said first contact portions and second contact portions are configured in said first space, said third contact portions are configured in said second space.

In one embodiment of the present invention, a mating electrical connector extends into said first space to connect said first contact portions and the second contact portions, and a storage article 80 is plugging into said second space to connect said third contact portions.

In one embodiment of the present invention, further comprising: a circuit board 170, wherein said circuit board, said first compressed terminals, said second compressed terminals and said liberative terminals respectively include a first connecting portion, a second connecting portion and a third connecting portion near to said opening, said first connecting portions and said second connecting portions extends to said circuit board, and said third connecting portions engaging said circuit board electrically connecting with said circuit board.

In one embodiment of the present invention,-said extending direction of said third connecting portions is perpendicular to said longitudinal direction and is configuring in line.

In one embodiment of the present invention, said first compressed terminals include a first body portion 136 between said first contact portion and said first connecting portion; said second compressed terminals include a second body portion 146 between said second contact portion and said second connecting portion; said liberative terminals include a third body portion 166 between said third contact portion and said third connecting portion; wherein the first body portions, the second body portions and the third body portions extend longitudinally and are configuring in different planes respectively.

In one embodiment of the present invention, said tongue includes a plurality of slots 124b which are perpendicular to said longitudinal direction, said second contact portion of said second compressed terminals is configuring above said slots and adapting to extend into said slots respectively, wherein the size of said slots is larger than the size of said second contact portion.

In one embodiment of the present invention, said shielding component includes two first engaging units 116; said tongue includes two second engaging units 124c corresponding to said first engaging units.

In one embodiment of the present invention, the quantity of said first compressed terminals is four; the quantity of said second compressed terminals is five; said first compressed terminals and second compressed terminals are utilized to transmit a USB 3.0 signal.

In view of the above description, the first compressed terminals and the second compressed terminals of the electrical connector in the present invention are insert-molded in the principle housing using the process of insert-molding, and the liberative terminals are securely fixed on the supplementary housing. In manufacturing process, these measures have simpler producing procedure and lower cost. Moreover, the first compressed terminals, the second compressed terminals and the liberative terminals of the electrical connector in the present invention are allocated on the different planes respectively, so the signal interference among these elements are reduced.

### BRIEF DESCRIPTION OF THE DRAWINGS

FIG. 1 is an exploded view of a prior electrical connector.

FIG. 2 is a three-dimensional view when the storage article is plugged into an electrical connector according to one embodiment of the present invention.

FIG. 3 is an exploded view of FIG. 2.

FIG. 4 is a three-dimensional view when removing the shielding component and the storage article of FIG. 2.

FIG. 5 is a three-dimensional bottom view of FIG. 4.

FIG. 6 is a top view of FIG. 4.

FIG. 7 is a sectional view of the A-A line segment of FIG. 6.

FIG. 8 is an exploded view of an electrical connector according to another embodiment of the present invention.

FIG. 9 is a three-dimensional view when removing the shielding component of the electrical connector in FIG. 8.

FIG. 10 is a three-dimensional view of the first compressed terminals, the second compressed terminals, the supplementary housing and the liberative terminals of the electrical connector in FIG. 8.

FIG. 11 is a side view of FIG. 10.

FIG. 12 is another exploded view of FIG. 2.

FIG. 13 is another three-dimensional view when removing the shielding component and the storage article of FIG. 2.

FIG. 14 is a three-dimensional bottom view of FIG. 13.

FIG. 15 is a top view of FIG. 13.

FIG. 16 is a sectional view of the A-A line segment of FIG. 15.

FIG. 17 is a side view of the first compressed terminals, the second compressed terminals, the supplementary housing and the liberative terminals of the electrical connector in FIG. 12.

FIG. 18 is a rear view of FIG. 13.

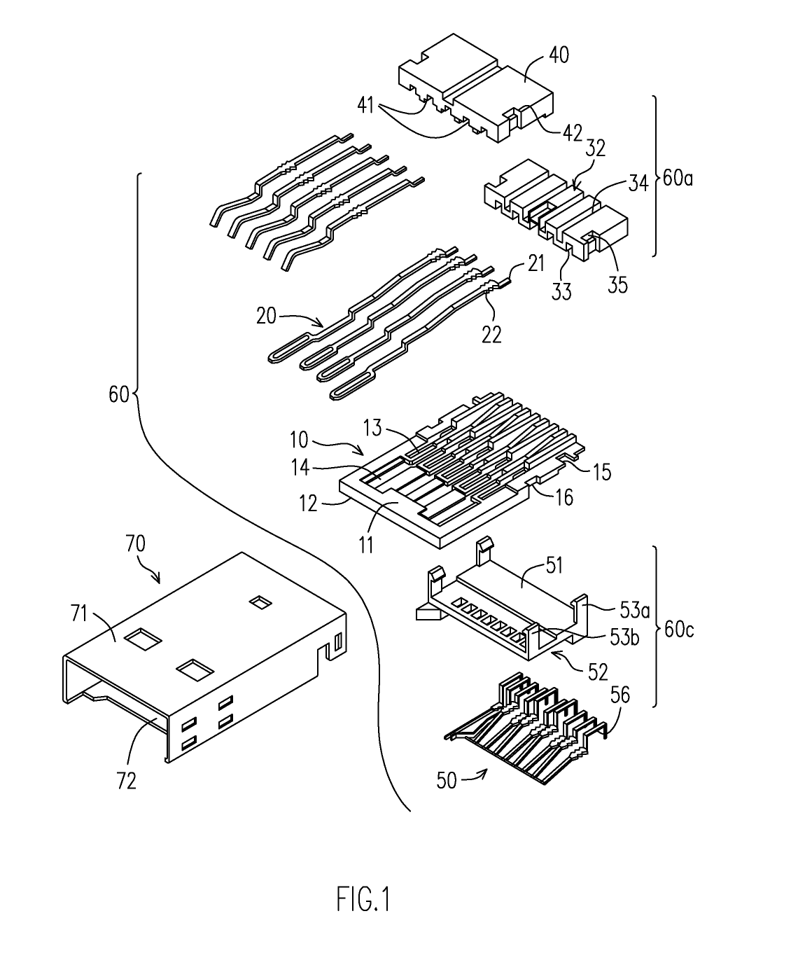

### DETAILED DESCRIPTION OF THE EMBODIMENT(S)

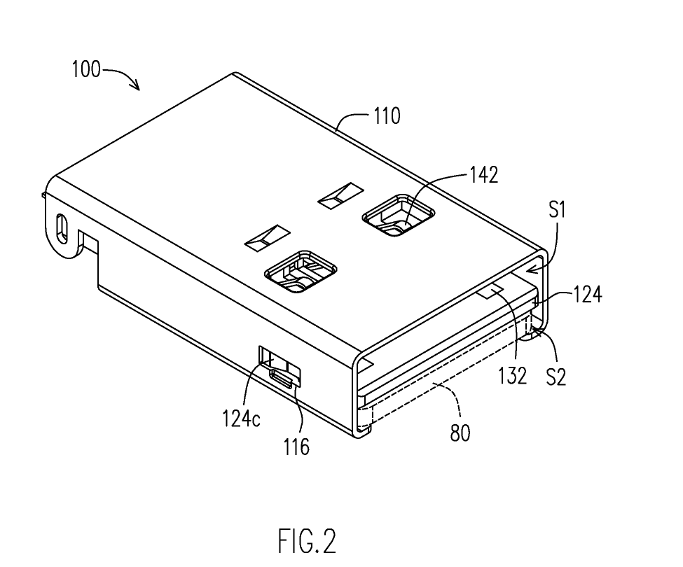

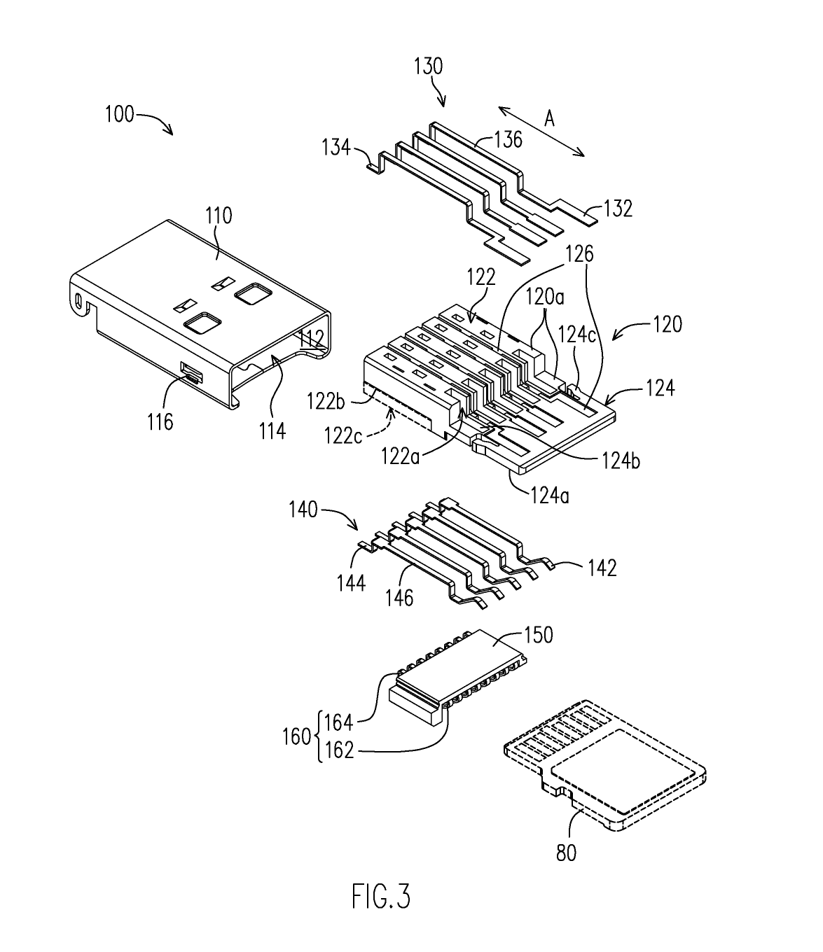

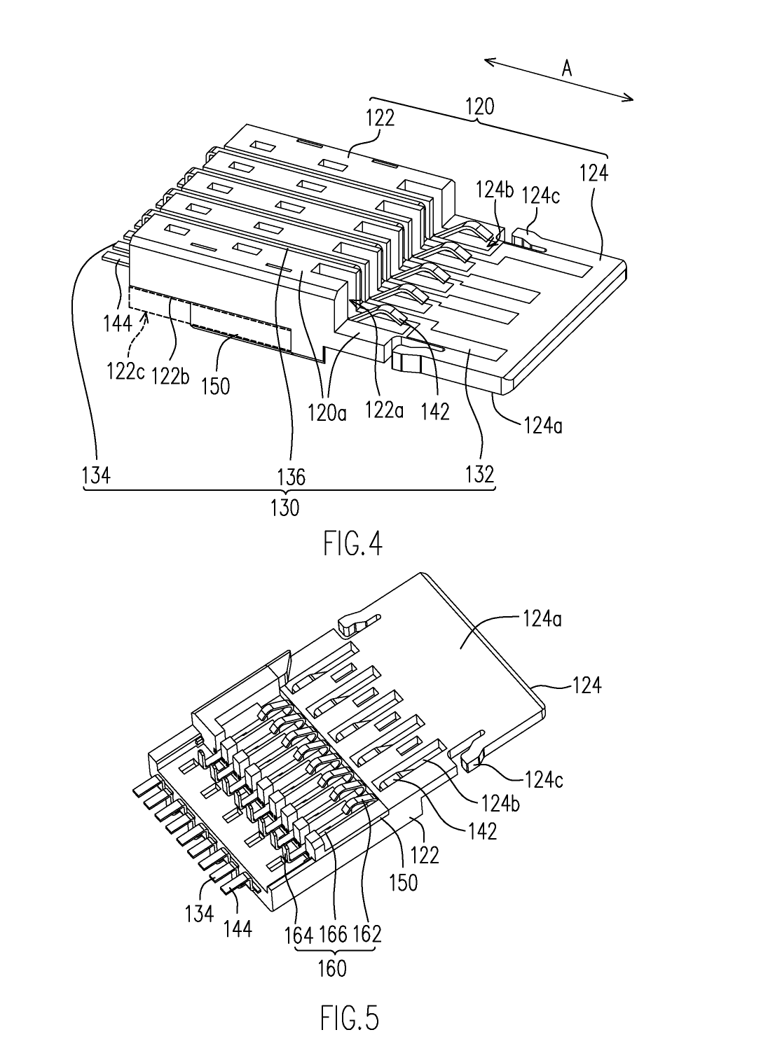

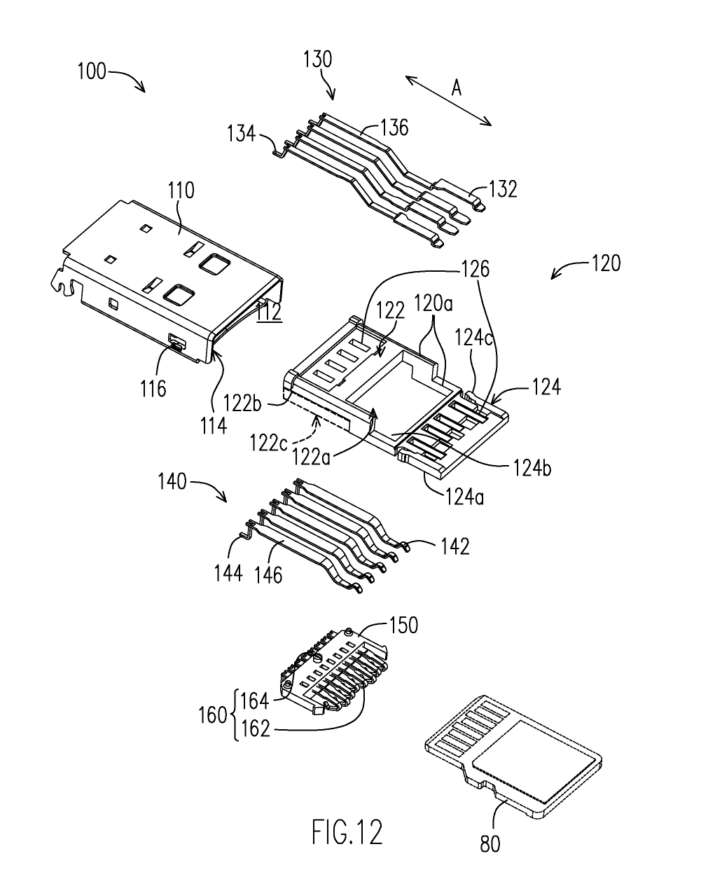

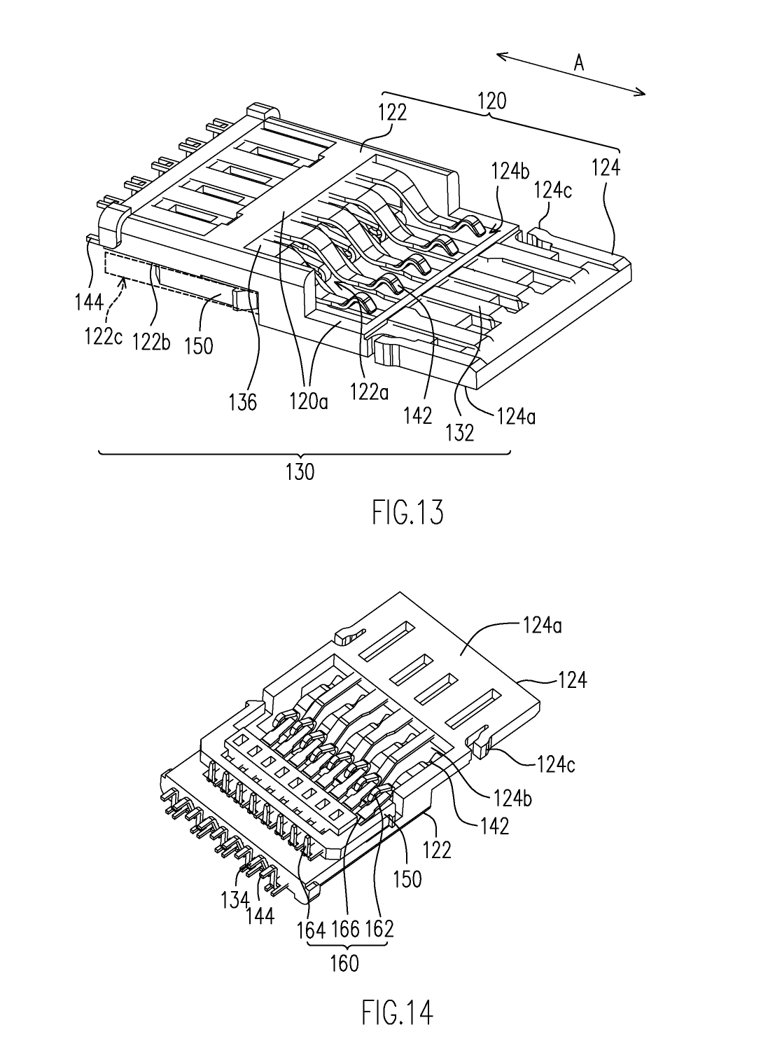

FIG. 2 is a three-dimensional view when the storage article is plugged into an electrical connector according to one embodiment of the present invention. FIG. 3 is an exploded view of FIG. 2. FIG. 4 is a three-dimensional view when removing the shielding component and the storage article of FIG. 2. FIG. 5 is a three-dimensional bottom view of FIG. 4. FIG. 12 is another exploded view of FIG. 2. FIG. 13 is another three-dimensional view when removing the shielding component and the storage article of FIG. 2. FIG. 14 is a three-dimensional bottom view of FIG. 13.

Referring to FIGS. 2 to 5, the electrical connector 100 in this embodiment comprises a shielding component 110, a principle housing 120, a plurality of first compressed terminals 130, a plurality of second compressed terminals 140, a supplementary housing 150 and a plurality of liberative terminals 160.

The following terms of “compressed terminals” 130, 140 and “liberative terminal” 160 are referred to nouns with regard to their substantial concept, in which the “compressed terminals” 130 and 140 are defined as being able to perform electrical connection in a position above a tongue 124 by which a consideration of lower flexibility space is required, as shown in FIG. 7, and the “liberative terminal” 160 is disposed within a vacant portion 122c, by which there is more extra space for terminal flexibility and has more free on terminal design, as shown in FIG. 4. This definition is preferably understood as a concept of the present invention, but should not be contextually replaced to dodge the spirit of the present invention.

The shielding component 110 has a hollow chamber 112 and an opening 114 communicating with the hollow chamber 112. In this embodiment, the shielding component 110 is a metal casing for providing the effect of electromagnetic shielding. The principle housing 120, which includes a main body 122 and a tongue 124 protruding and extending axially from the main body 122 along the A direction, is disposed in the hollow chamber 112. Compared to the main body 122, the tongue portion 124 is closer to the opening 114. And the main body 122 includes recessions 122a which axially extend along the A direction and a vacant portion 122c which is sunk within a bottom surface 122b of the main body 122. In this embodiment, the principle housing 120 is made of insulating material, such as plastic resin of rubber core or high-molecular material, but the material of the principle housing 120 is not limited to this as long as the material is of insulation.

The first compressed terminals 130 are injection molded to embed on the upper surface 120a of the principle housing 120. In detail, the top surface of the main body 122 and the top surface of the tongue 124 are provided with a plurality of recesses 126. The first press-fit terminals 130 are injection molded inside these recesses 126. The second press-fit terminals 140 are injection molded to embed within the principle housing 120 and are disposed within these recessions 122a. In practical manufacturing, the first compressed terminals 130 and the second compressed terminals 140 can be in advance interposed in a specific position of a die, and then the principle housing 120 is injected in the die using the injection-molding process so as to securely fix the first compressed terminals 130 and the second compressed terminals 140 to the principle housing 120. In FIG. 3, the penetrating groove 122a is disposed around the second compressed terminals 140, but in FIG. 12, the recessions 122a can be changed as an open space by which terminals other than the second compressed terminals 140 are also permitted to be disposed in this space. Therefore, the effect of dielectric coefficient due to insulating material becomes less when high frequency signals are transmitted.

While the invention has been described in terms of various specific embodiments, those skilled in the art will recognize that the invention can be practiced with modification within the spirit and scope of the claims.

In this embodiment, the quantity of the first compressed terminals 130 is four, and the quantity of the second compressed terminals 140 is five, in which the first compressed terminals 130 and second compressed terminals 140 are utilized to transmit USB 3.0 signal, which means, in other words, the electrical connector 100 in this embodiment is a USB 3.0 electrical connector. But in other embodiments, the quantities of the first compressed terminals 130 and second compressed terminals 140 are not limited to these quantities. The electrical connector 100 is also not limited to only as the USB 3.0 electrical connector.

The supplementary housing 150 is disposed in the concave portion 122c. In this embodiment, the size of the supplementary housing 150 is slightly smaller than the size of the concave portion 122c. Therefore, when the supplementary housing 150 is disposed in the vacant portion 122c, the supplementary housing 150 does not occupy all space of the vacant portion 122c. Moreover, the supplementary housing 150 is disposed inside the vacant portion 122c in a position near to the tongue 124. But the position of the supplementary housing 150 in relation to the vacant portion 122c is not limited to this position. In other embodiments, the supplementary housing 150 can also be disposed in the vacant portion 122c far away from the area of the tongue 124.

The liberative terminals 160 are securely fixed on the supplementary housing 150. In this embodiment, the liberative terminals 160 can also be injection molded within the supplementary housing 150 using the process of injection-molding, Alternatively, after the liberative terminals 160 and the supplementary housing 150 are respectively produced, they are fixed on the supplementary housing 150 using an assembly manner. Of course, the molding method of the liberative terminals 160 and the connecting method between the liberative terminals 160 and the supplementary housing 150 are not limited to the above.

Referring to FIGS. 2 to 4, in this embodiment, a first space Si communicating with the opening 114 is defined between the upper surface 120a of the principle housing 120 and the shielding component 110. A second space S2 communicating with the opening 114 is defined between the bottom surface 124a of the tongue 124, the supplementary housing 150 and the shielding component 110. The first compressed terminals 130, the second compressed terminals 140 and the liberative terminals 160 respectively include a first contact portion 132, a second contact portion 142 and a third contact portion 162 neighboring to the opening 114. The first contact portions 132 and second contact portions 142 are positioned in the first space S1. The third contact portions 162 are positioned in the second space S2.

A mating electrical connector, not shown, extends into the first space Si to connecting the first contact portions 132 and the second contact portions 142. And a storage article 80 is plugging into the second space S2 for connecting the third contact portions 162. In other words, the electrical connector 100 in this embodiment can be used as a card reader and the storage article 80 such as a memory card can be plugged into the second space S2 of the electrical connector 100 for contacting the third contact portions 162 so as to electrically connect the electrical connector 100. Moreover, the electrical connector 100 in this embodiment can go with the storage article 80 to plug into the mating electrical connector, such as a USB socket connector of an electrical device so as to connect the electrical connector 100 with the electrical device by which the electrical device can access the storage article 80 via the electrical connector 100. It is noted that, in this embodiment, the quantity of the liberative terminals 160 is eight in consideration of being connected by a SD memory card, but in other embodiments, the quantity of the liberative terminals 160 in an electrical connector 100 can be adjusted according to other kinds of the storage article 80. The quantity of the liberative terminals 160 and the type of the storage article 80 are not limited to the above.

Moreover, referring to FIG. 4, in this embodiment, the tongue 124 includes a plurality of slots 124b which are perpendicular to the axial direction A. And the size of the slots 124b is larger than the size of the second contact portion 142. The second contact portion 142 of the second compressed terminals 140 are disposed on these slots 124b and can extend into these slots 124b respectively. In other words, when the terminals of the mating electrical connector contacts the second contact portion 142 of the second compressed terminals 140, the second contact portion 142 are pushed to extend within the slots 124b. The slots 124b on the tongue 124 are allocated to provide a larger flexible space for the second contact portion 142. In the embodiment of FIG. 12, the through-groove 122a is an open space in such a manner that the through-holes 124b and the recessions 122a are molded.

Moreover, please referring to FIGS. 2 and 4, the shielding component 110 includes two first engaging units 116. The tongue 124 includes two second engaging units 124c which corresponded to these two first engaging units 116. In this embodiment, the first engaging unit 116 is a hole and the second engaging unit 124c is a hook by which the principle housing 120 engages the two first engaging units 116 on both sides of the shielding component 110 through the two second engaging unit 124c of the tongue 124 so as to secure the hollow chamber 112 of the shielding component 110.

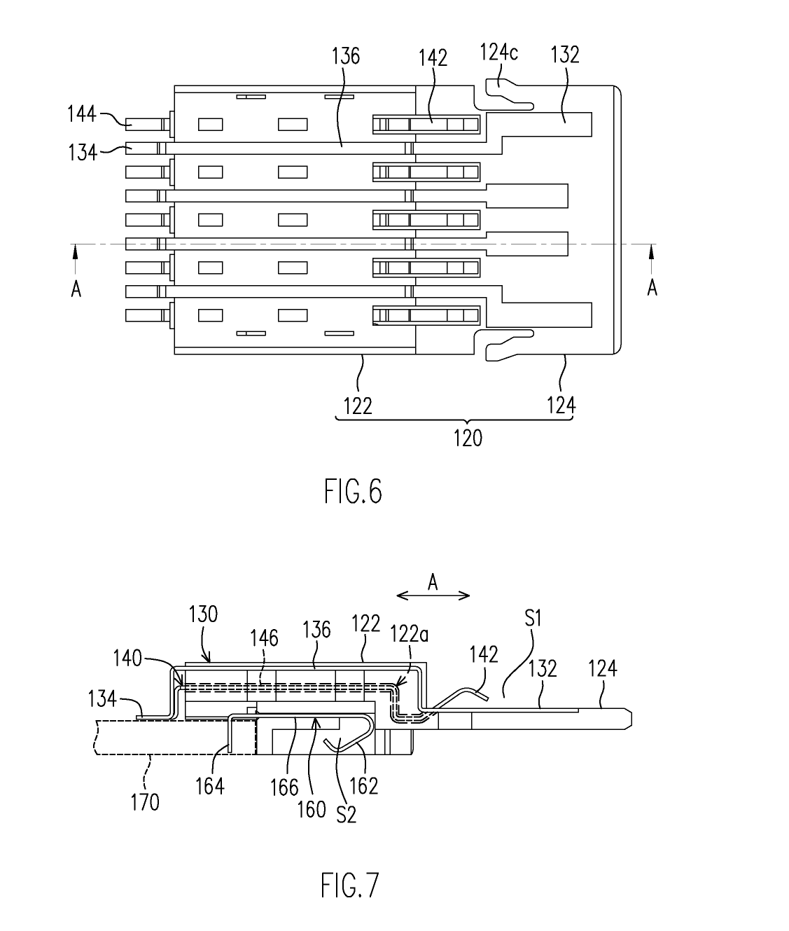

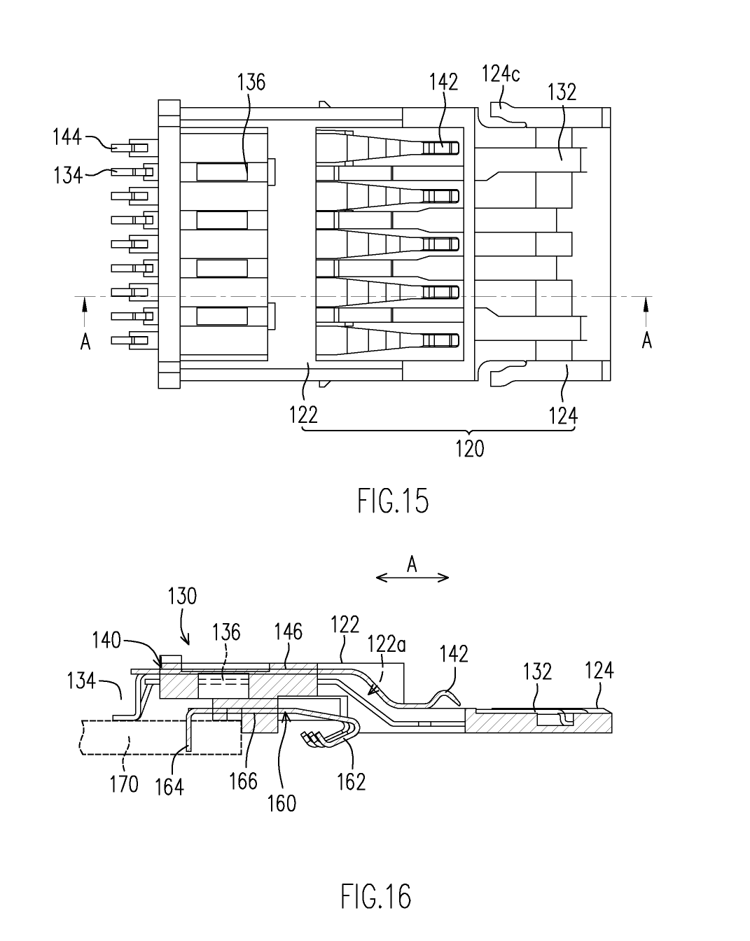

FIG. 6 is a top view of FIG. 4. FIG. 7 is a sectional view of the A-A line segment of FIG. 6. FIG. 15 is a top view of FIG. 13. FIG. 16 is a sectional view of the A-A line segment of FIG. 15. Please refer to FIGS. 6, 7, 15 and 16. The first compressed terminals 130 include a first connecting portion 134 far from the opening 114 and a first body portion 136 located between the first contact 132 portion and the first connecting portion 134. The second compressed terminals 140 include a second connecting portion 144 far from the opening 114 and a second body portion 146 disposed between the second contact portion 142 and the second connecting portion 144. The liberative terminals 160 include a third connecting portion 164 far from the opening 114 and a third body portion 166 disposed between the third contact portion 162 and the third connecting portion 164. As shown in FIG. 7, the first body portions 136 of the first compressed terminals 130, the second body portions 146 of the second press-fit terminals 140 and the third body portions 166 of the liberative terminals 160 axially extends toward the A direction. And the electrical connector 100 in this embodiment further includes a circuit board 170, in which the first connecting portions 134 and the second connecting portions 144 extends to the circuit board 170 respectively. And the third connecting portions 164 penetrate through the circuit board 170 to electrically connect the circuit board 170. In addition, as shown in FIG. 5, in this embodiment, the extending direction of the third connecting portions 164 is perpendicular to the axial direction A and is lined along a straight line.

In this embodiment, these first compressed terminals 130, second compressed terminals 140 and the liberative terminals 160 are located on different planes respectively. More specifically, the first body portion 136 of the first compressed terminals 130, the second body portion 146 of the second compressed terminals 140 and the third connecting portions 166 of the liberative terminals 160 are located on the different planes respectively. In other words, the first body portion 136, the second body portion 146 and the third body portion 166 are at different heights to reduce the signal interference among the first compressed terminals 130, the second compressed terminals 140 and the liberative terminals 160.

The above only schematically explains one structure of an electrical connector, but the electrical connector in the present invention is not limited to the structure. The following will provide another electrical connector.

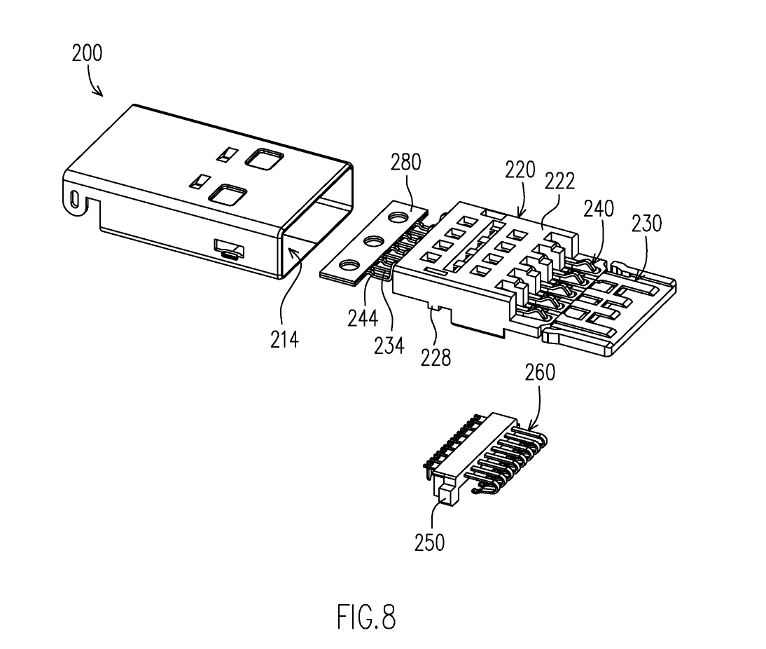

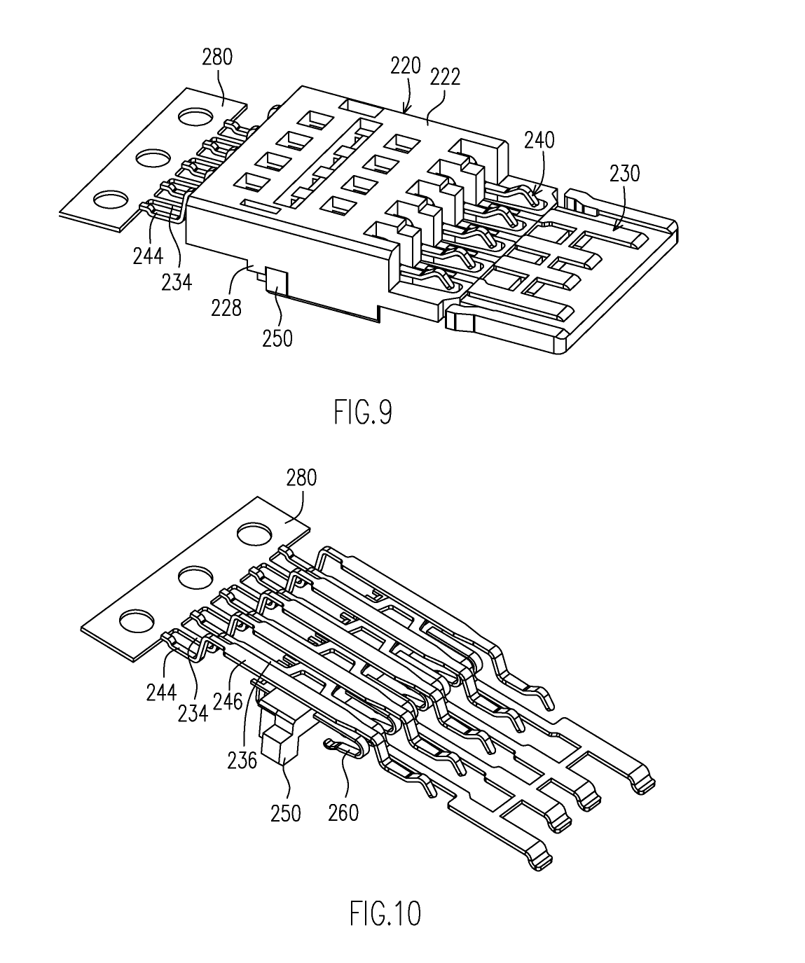

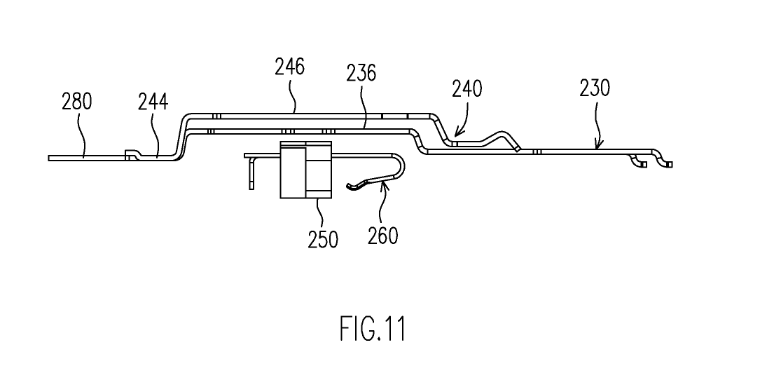

FIG. 8 is an exploded view of an electrical connector according another embodiment of the present invention. FIG. 9 is a three-dimensional view when removing the shielding component of the electrical connector in FIG. 8. FIG. 10 is a three-dimensional view of the first compressed terminals, the second compressed terminals, the supplementary housing and the liberative terminals of the electrical connector in FIG. 8. FIG. 11 is a side view of FIG. 10. FIG. 17 is a side view of the first compressed terminals, the second compressed terminals, the supplementary housing and the liberative terminals of the electrical connector in FIG. 12.

Please refer to FIGS. 8 to 11 and 17. The difference between the electrical connector 200 of this embodiment and that of the previous embodiment is that: in this embodiment, the electrical connector 200 further includes a connecting board 280 to which the first connecting portions 234 of the first compressed terminals 230 and the second connecting portions 244 of the second compressed terminals 240 are connected. The connecting board 280 is for securing terminals in position and is removed after the production procedure. Another difference there between is the shape of the supplementary housing 250, in which, in this embodiment, the principle housing 220 has an engaging portion 228 in a position corresponding to the supplementary housing 250 for limiting the supplementary housing 250 not to move away from the opening 214 in relation to the principle housing 220. FIG. 14 is another embodiment illustrating the engagement of the supplementary housing 150. Moreover, in the previous embodiment, as shown in FIG. 7, the first compressed terminals 130 is situated on the upper surface 120a of the principle housing 120, and the height of the first body portion 136 of the first compressed terminals 130 is higher than the height of the second body portion 146 of the second compressed terminals 140. On the contrary, in this embodiment, as shown in FIG. 9, the first compressed terminals 230 penetrates through the vacant portion 222 of the principle housing 220, and, as shown in FIG. 11, the height of the second body portion 246 of the second compressed terminals 240 is higher than the height of the first body portion 236 of the first compressed terminals 230. FIG. 17 applies a similar design.

In spite that there exist different between the two embodiments, the first compressed terminals 130, 230 and the second compressed terminals 140, 240 of these two electrical connector 100, 200 are both injection molded in the principle housing 120, 220 using the process of injection-molding, and the liberative terminals 160, 260 are securely fixed on the supplementary housing 150, 250, which poses, in manufacturing process, the advantage of simpler producing procedure and lower cost. Moreover, the first compressed terminals 130, 230, the second compressed terminals 140, 240 and the liberative terminals 160, 260 of the electrical connectors in the above two embodiments are allocated on the different planes respectively, so the signal interference among these elements are reduced.

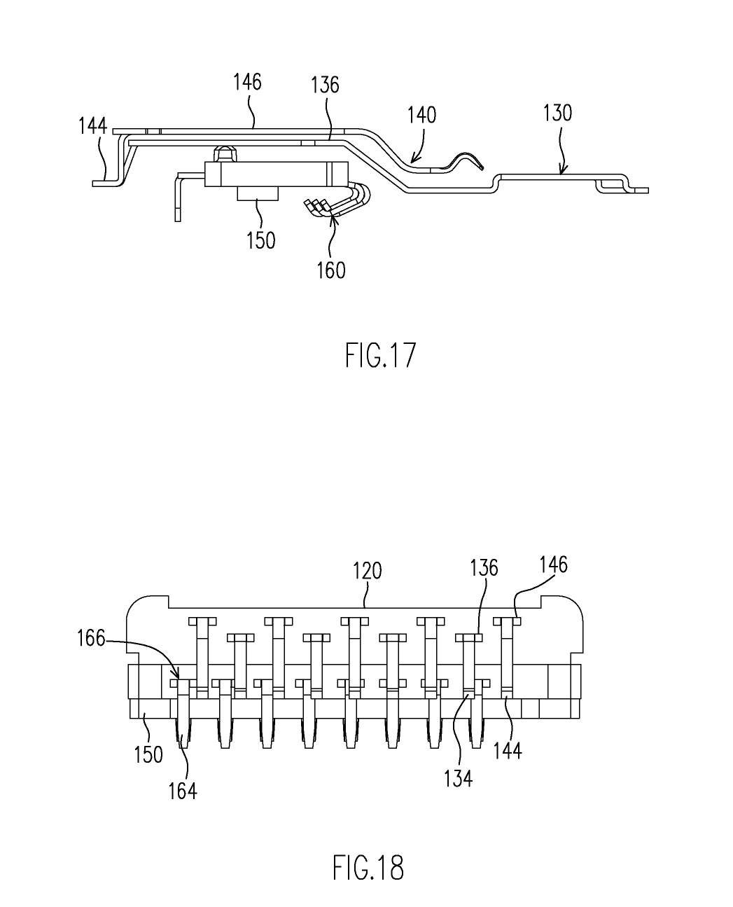

FIG. 18 is a rear view of FIG. 13. As shown in this figure, the first body portion 136, which extends downward to form the first connecting portion 134, is allocated inside the principle housing 120. And between two first connecting portions 134, there is a second connecting portion 144 extending from a second body portion 146. The third body portion 166, which is allocated inside the supplementary housing 150, extends downward to form a third connecting portion 164. The third connecting portion 164 is dual-in-line package (DIP). And the first connecting portion 134 and the second connecting portion 144 are surface mount technology (SMT). The above descriptions only schematically explain one structure of a connecting portion, but the present invention is not limited to these descriptions. Other connecting portion fallen with the spirit of the present invention shall be included.

While the invention has been described in terms of various specific embodiments, those skilled in the art will recognize that the invention can be practiced with modification within the spirit and scope of the claims.

What is claimed is:

1. An electrical connector, comprising:
a shielding component provided with a hollow chamber;
a principle housing installed in said hollow chamber, including a main body and a tongue protruded from said main body in a longitudinal direction, wherein said tongue is more closer to said opening, and wherein said main body includes recessions extending in said longitudinal direction, and a vacant portion provided by the bottom of said main body;
a plurality of first compressed terminals been insert-molded to an upper surface of said main body;
a plurality of second compressed terminals been insert-molded to said main body and received by said recessions;
a supplementary housing disposed in part of said vacant portion nearby the location of said tongue; and
a plurality of liberative terminals been retained on said supplementary housing,
wherein the major part of terminal body of above-described first compressed terminals, second compressed terminals and liberative terminals are respectively on the planes which share no co-planar.

2. The electrical connector of claim 1, wherein a first space communicated with said opening is defined between said upper surface and said shielding component of said principle housing; and a second space communicated with said opening is defined between a bottom surface of said tongue portion, said supplementary housing and said shielding component.

3. The electrical connector of claim 2, wherein said first compressed terminals, said second compressed terminals and said liberative terminals respectively include a first contact portion, a second contact portion and a third contact portion near to said opening, said first contact portions and second contact portions are configured in said first space, said third contact portions are configured in said second space.

4. The electrical connector of claim 3, wherein a mating electrical connector extends into said first space to connect said first contact portions and the second contact portions, and a storage article is plugging into said second space to connect said third contact portions.

5. The electrical connector of claim 3, further comprising: a circuit board, wherein said circuit board, said first compressed terminals, said second compressed terminals and said liberative terminals respectively include a first connecting portion, a second connecting portion and a third connecting portion near to said opening, said first connecting portions and said second connecting portions extends to said circuit board, and said third connecting portions engaging said circuit board electrically connecting with said circuit board.

6. The electrical connector of claim 5, wherein said extending direction of said third connecting portions is perpendicular to said longitudinal direction and is configuring in line.

7. The electrical connector of claim 5, wherein said first compressed terminals include a first body portion between said first contact portion and said first connecting portion; said second compressed terminals include a second body portion between said second contact portion and said second connecting portion; said liberative terminals include a third body portion between said third contact portion and said third connecting portion; wherein the first body portions, the second body portions and the third body portions extend longitudinally and are configuring in different planes respectively.

8. The electrical connector of claim 3, wherein said tongue includes a plurality of slots which are perpendicular to said longitudinal direction, said second contact portion of said second compressed terminals is configuring above said slots and adapting to extend into said slots respectively, wherein the size of said slots is larger than the size of said second contact portion.

9. The electrical connector of claim 1, wherein said shielding component includes two first engaging units; said tongue includes two second engaging units corresponding to said first engaging units.

10. The electrical connector of claim 1, wherein the quantity of said first compressed terminals is four; the quantity of said second compressed terminals is five; said first compressed terminals and second compressed terminals are utilized to transmit a USB 3.0 signal.
